(19) United States
(12) Patent Application Publication
(10) Pub. No.: US 2012/0246408 A1
(43) Pub. Date: Sep. 27, 2012

(54) ARITHMETIC PROCESSING DEVICE AND CONTROLLING METHOD THEREOF

(75) Inventors: Shuji YAMAMURA, Kawasaki (JP); Kuniki Morita, Kawasaki (JP)

(73) Assignee: FUJITSU LIMITED, Kawasaki-shi (JP)

(21) Appl. No.: 13/359,605

(22) Filed: Jan. 27, 2012

(30) Foreign Application Priority Data
Mar. 25, 2011 (JP) 2011-068861

(51) Int. Cl. G06F 12/08

(52) U.S. Cl. 711/125; 711/E12.02

(57) ABSTRACT

A physical process ID (PPID) is stored for each cache block of each set, and a MAX WAY number for each PPID value is stored for each of index values #1 to #n. A MAX WAY number corresponding to a certain PPID value in a certain index value indicates the maximum number of cache blocks having the PPID value, which can be stored in the index value. The number of ways at the time of a cache miss is controlled not to exceed the MAX WAY number of each PPID value for each index value.

### CROSS-REFERENCE TO RELATED APPLICATION

This application is based upon and claims the benefit of priority of the prior Japanese Patent Application No. 2011-068861, filed on Mar. 25, 2011, the entire contents of which are incorporated herein by reference.

### FIELD

The embodiments discussed herein are related to a an arithmetic processing device, and a controlling method of the arithmetic processing device.

### BACKGROUND

With recent improvements in operation frequencies of processors, a delay time of a memory access made from the inside of a processor to a main memory relatively increases, and affects the performance of the entire system. Most processors include a high-speed memory of a small capacity called a cache memory in order to conceal a memory access delay time.

In a cache memory, data is managed in units called cache lines (or simply referred to as “lines”) or cache blocks (or simply referred to as “blocks”). When a data access request is made from a processor, it is needed to quickly search whether or not data exists in any of lines within a cache.

Therefore, a process such as a search or the like is executed by partitioning the cache memory.

Conventionally, a first conventional technique called Modified LRU Replacement method is known as a technique of partitioning and managing a shared cache area by an operating system (OS) that is executed by a processor. In the first conventional technique, the number of cache blocks used respectively by each of all processes that are operating in the system is counted.

Additionally, a second conventional technique of storing a process ID for identifying a process executed by a processor in a tag (cache tag) within a cache block and of controlling a cache flush based on the process ID is known.

Furthermore, a third conventional technique of recording a process ID within a cache tag and of controlling a cache flush by comparing a request source process ID with the process ID within the cache tag at the time of a cache access is known.

### SUMMARY

An arithmetic processing device according to an embodiment of the present invention includes: an instruction control unit configured to execute a process including a plurality of instructions, and to issue a memory access request including index information and tag information; a cache memory unit configured to include a plurality of cache ways having, for each of a plurality of indexes, a block holding a tag, data corresponding to the memory access request, and a process identifier for identifying a process executed by the instruction control unit; an index decoding unit configured to decode the index information included in the received memory access request, and to select a block corresponding to the decoded index information; a comparison unit configured to make a comparison between the tag information included in the received memory access request and a tag included in the block selected by the index decoding unit, and to output data included in the block selected by the index decoding unit if the tag information and the tag match; and a control unit configured to decide, for each of the plurality of indexes of the cache memory unit, the number of cache ways used by the process identified with the process identifier based on maximum cache way number information set for each process identifier.

The object and advantages of the invention will be realized and attained by means of the elements and combinations particularly pointed out in the claims.

It is to be understood that both the forgoing general description and the following detailed description are exemplary and explanatory and are not restrictive of the invention, as claimed.

### BRIEF DESCRIPTION OF DRAWINGS

FIG. 1 is a block diagram illustrating an embodiment of a cache memory;

FIG. 2 illustrates an example of a data configuration of a table of the number of cache blocks, which an OS provides to each PPID value;

FIG. 3 illustrates an example of partitioning the cache memory;

FIG. 4 is an explanatory view of a replacement operation performed when a cache miss occurs;

FIG. 5 illustrates a hash unit;

FIG. 6 illustrates a process ID map unit;

FIG. 7 is a schematic (No. 1) illustrating an example of a hardware configuration of a cache tag unit;

FIG. 8 is a schematic (No. 2) illustrating an example of the hardware configuration of the cache tag unit;

FIG. 9 is a flowchart illustrating a process for deciding a MAX WAY number based on the number of cache blocks, which the OS provides to each PPID value;

FIG. 10 illustrates a program pseudo code that represents a process for deciding a MAX WAY number based on the number of cache blocks, which the OS provides to each PPID value;

FIG. 11 illustrates a hardware configuration example of a replacement way control circuit;

FIG. 12 illustrates a MAX WAY number update mechanism.

FIG. 13 illustrates an example of a hardware configuration of a hash unit;

FIG. 14 is an explanatory view (No. 1) of operations of the hash unit;

FIG. 15 is an explanatory view (No. 2) of operations of the hash unit;

FIG. 16 illustrates an example of a hardware configuration of a process ID map unit;

FIG. 17 illustrates a PPID write mechanism;

FIG. 18 illustrates a configuration example of a processor system including a cache memory system according to this embodiment;

FIG. 19 is an explanatory view of an operation example when a total of the numbers of ways respectively requested by processes scheduled at the same time exceeds the number of ways provided in the cache memory; and

FIG. 20 is a flowchart illustrating operations for scheduling cache blocks based on a time and a priority.

### DESCRIPTION OF EMBODIMENTS

To improve the effective performance of a processor, high-speed operations of a cache memory are needed.

Each of cache blocks that configure each cache set (hereinafter referred to simply as a set) is configured with a validity flag that indicates validity/invalidity, a tag and data in order to quickly search whether or not data exists in any of lines within a cache memory. Each of the cache blocks has a size composed of, for example, 1 bit for the validity flag, 15 bits for the tag, and 128 bytes for the data. Here, the cache set means an area obtained by partitioning the cache memory. Each cache set includes a plurality of cache blocks.

In the meantime, by way of example, in a 32-bit address for a memory access, which is specified by a program, low-order 7 bits, succeeding 10 bits, and high-order 15 bits are used as a cache line offset, an index and a tag, respectively.

When a data read from an address is requested, a set indicated by an index address within the address is selected. Moreover, it is determined whether or not a tag stored in association with each cache block within the selected set matches a tag within the address. If the tags match, a cache hit is detected. If the tags mismatch, a cache miss is detected.

If the set is provided with cache blocks (each composed of a pair of data and a tag) of a plurality of ways at this time, a plurality of pieces of data having a different high-order address value (tag value) can be stored even in entries having the same index value. Such a cache memory data storing method is called a set associative method. An address space of a cache, which is smaller than that of a memory, is partitioned into sets, and, for example, a remainder number obtained by dividing a request address by the number of sets is defined as indexes, and thereby the number of sets corresponds to the number of indexes. Each of the sets (indexes) includes a plurality of blocks. The number of blocks that are simultaneously output by specifying an index is a way number. When n blocks in one line which is composed of n tags are simultaneously output, it is called an n-way set associative method.

If the size of written data is larger than an address range that can be specified with an index, there is a possibility that values of indexes that are part of an address in a plurality of pieces of data will match, leading to a conflict among these pieces of data in a cache line. Even in such a case, in the cache memory employing the set associative method, cache blocks can be selected from a plurality of ways without causing the conflict in the cache line even though lines having the same index are specified. For example, a cache memory composed of 4 ways can handle up to four pieces of data having the same index.

If the tags do not match in cache blocks of all ways in a specified line, or if the validity flag of a cache block having a tag detected to match indicates invalidity, it results in a cache miss, and data to be accessed is read from a main memory (main storage device). When a cache miss occurs, an unused way is selected from a specified set, and the data read from the main memory is newly held in a cache block of the selected way. As a result, a cache hit occurs when the held data is accessed next, eliminating the need for an access to the main memory. Consequently, a high-speed access is implemented. If all ways are in use at the time of a cache miss, one of the ways in use is selected, for example, with an algorithm called LRU (Least Recently Used), and data of a cache block in the selected way is replaced. In the LRU algorithm, data of the least recently used cache block is purged to the main memory, and is replaced with the data read from the main memory.

The cache memory of the set associative method has the above described configuration.

Embodiments for carrying out the present invention are described in detail below with reference to the drawings.

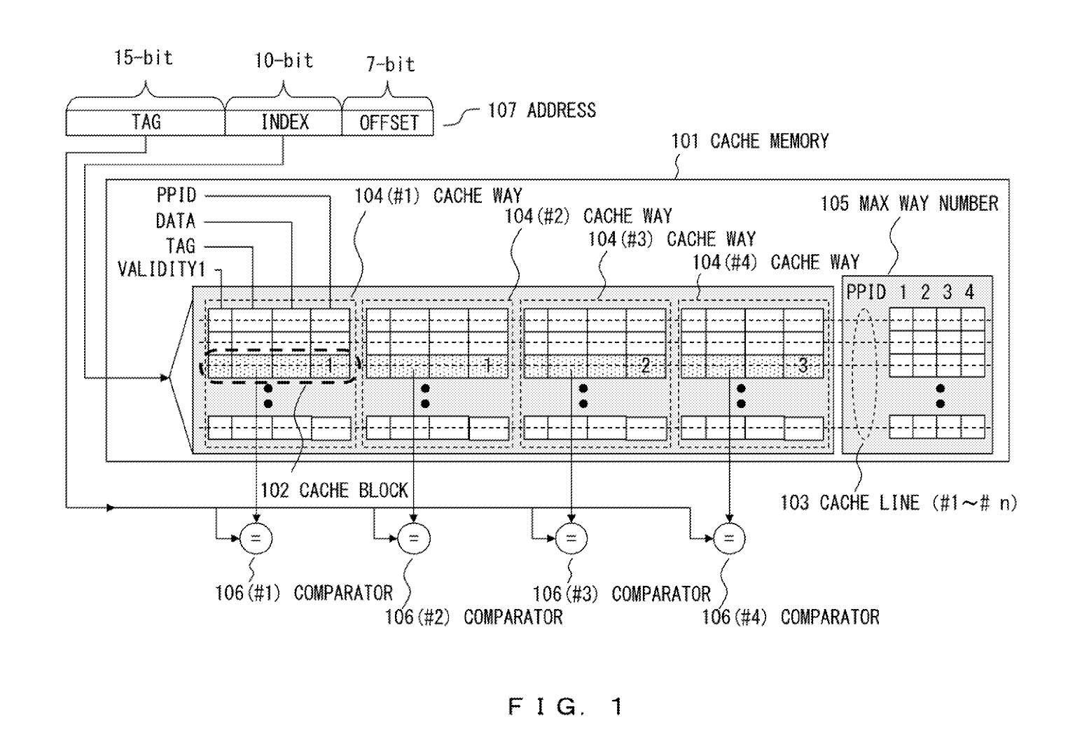

FIG. 1 is a block diagram illustrating an embodiment of a cache memory.

The cache memory 101 according to this embodiment is, for example, a 4-way or 8-way set associative cache memory.

In the cache memory 101, data is managed in units of sets 103 composed of a plurality of lines #1 to #n, and in units of cache blocks 102 belonging to each of the sets 103. For example, n=1024.

In the embodiment of FIG. 1, each of the cache blocks 102 that configure each of the sets 103 has a physical process ID (hereinafter referred to as PPID) in addition to a validity flag (for example, of 1 bit), a tag (for example, of 15 bits), and data (for example, of 128 bytes). The PPID is process identification information obtained by translating a process ID (hereinafter referred to as PID) managed by an operating system with a process ID map unit to be described later. The PPID is, for example, 2-bit data, with which, for example, 4 PPID values 0 to 3 can be identified. By storing the PPID, to which process each of the cache blocks 102 is allocated can be determined.

A data size definition of the cache memory 101 is calculated by “data size of the cache block 102× the number of cache indexes×the number of cache ways”. By way of example, the data size of a 4-way cache memory 101 is defined as follows when 1024 bytes is assumed to be 1 kilo byte.

(128 bytes×1024 indexes×4 ways)÷1024=512 kilo bytes.

In the meantime, an address 107 for a memory access, which is specified by a program, is designated, for example, with 32 bits. In this example, low-order 7 bits, succeeding 10 bits, and high-order 15 bits are used as a cache line offset, an index and a tag, respectively.

Additionally, in this embodiment, PPID obtained by translating, with the process ID map unit, PID that is specified by the operating system when a program is executed is provided to the cache memory 101.

With the above described configuration, when a data read/write access from/to the address 107 is specified, one of cache blocks #1 to #n within a set 103 is specified by the 10-bit index within the address 107.

As a result, a tag value of each of the cache blocks 102 (#i) in the set 103 is read from each of the cache ways 104 #1 to #4, and the read tag value is input to each of comparators 106 #1 to #4.

Each of the comparators 106 #1 to #4 detects whether or not the read tag value within each of the cache blocks 102 (#i) matches the tag value within the specified address 107. As a result, a cache hit is detected for the cache block 102 (#i) read by any of the comparators 106 #1 to #4 that detect a match between the tag values, and the data is read/written from/to this cache block 102 (i).

If none of the comparators 106 detect a match between the tag values, or if the validity flag of the cache block 102 (#i) having the tag value detected to match indicates invalidity, it results in a cache miss. Therefore, the address in the main memory is accessed. When the cache miss occurs, the data is newly held in a cache block of an unused way selected in a specified line. As a result, a cache hit occurs at the time of the next access, eliminating the need for an access to the main memory. Consequently, a high-speed access is implemented.

If all the ways are in use at the time of the cache miss, the following purge control is performed in this embodiment.

Initially, in this embodiment, PPID is stored for each of the cache blocks 102 in each of the sets 103, and the maximum number of ways (MAX WAY number) 105 for each of PPID values (such as 1 to 4) is stored for each of the index values #1 to #n. A MAX WAY number 105 corresponding to a certain PPID value in a certain index value indicates the maximum number of cache blocks that have the PPID and can be stored in the index value. In this embodiment, the purge control is performed for each of the index values so as not to exceed the MAX WAY number 105 of each of the PPID values.

A ratio of the MAX WAY number 105 for each of the PPID values is decided based on the number of cache blocks for each of the PPID values, which is decided by the operating system (OS). In this case, if a size allocation among the PPID values within the cache memory 101, namely, a size of an area of the cache memory, which can be used by each of the PPIDs, is changed, a MAX WAY number 105 for each of the PPID values of an index value is sequentially changed when each of the index values is accessed. If the cache memory 101 is simply partitioned based on the PPID values, PPID information of all the cache blocks 102 within the cache memory 101 need to be rewritten when a partitioning amount is changed, leading to an increase in an update overhead. In contrast, in this embodiment, a size allocation among PPIDs can be dynamically changed in units of index values without rewriting all the cache blocks 102 at one time. Therefore, an information update is minimized, whereby a partitioning amount can be changed with a small overhead.

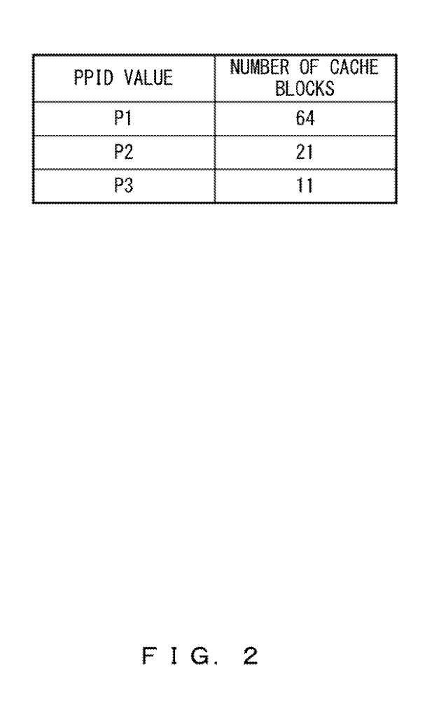

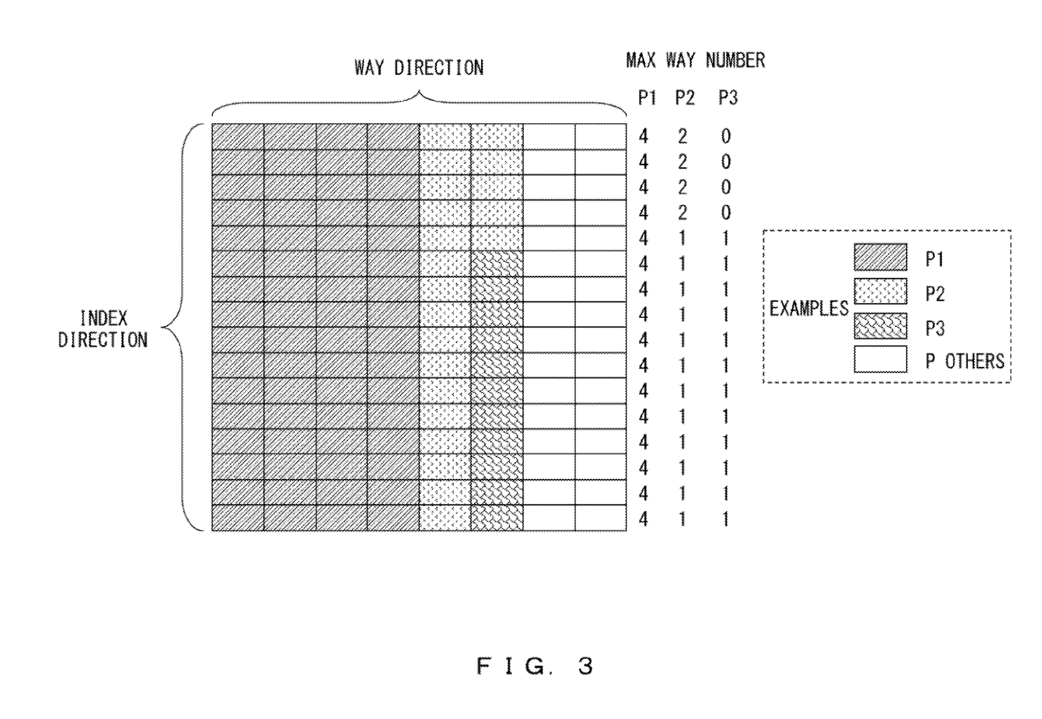

FIG. 2 illustrates an example of a data configuration of a table of the maximum number of cache blocks, which the OS provides to each of the PPID values. If the PPID values are P1, P2 and P3, their maximum numbers of cache blocks are, for example, 64, 21 and 11, respectively. FIG. 3 illustrates an example of partitioning the cache memory 101 in this embodiment according to the contents of the table illustrated in FIG. 2. For this partitioning process, an example where the number of cache ways 104 is 8 is provided. The number of indexes in the cache memory is the number that results from using 10 bits or 11 bits. However, for ease of explanation, the description is provided by assuming that there are 16 indexes in an index direction. AMAX WAY number 105 for each of the PPID values (P1, P2 and P3 in FIG. 3) is held for each of the index values. Moreover, the MAX WAY numbers 105 respectively for the index values are set so that each of the MAX WAY numbers 105 provided to each of the PPID values becomes equal to the number of cache blocks, which is set in the table of FIG. 2 and the OS provides to each of the PPID values, in the entire cache memory 101.

When a cache miss occurs for a cache block 102 having a certain PPID value in a specified index value, the following operation is performed. Namely, a comparison is made between a total number of cache ways already allocated to the PPID value in the set 103 and a MAX WAY number 105 stored in association with the PPID value. If the total number of already allocated cache ways is smaller than the MAX WAY number 105, the following operation is performed. Namely, a replacement block is selected from among cache blocks in which the total number of cache ways which have been allocated exceeds the MAX WAY number 105 corresponding to other PPID values in the cache blocks already allocated to these PPID values in the index value.

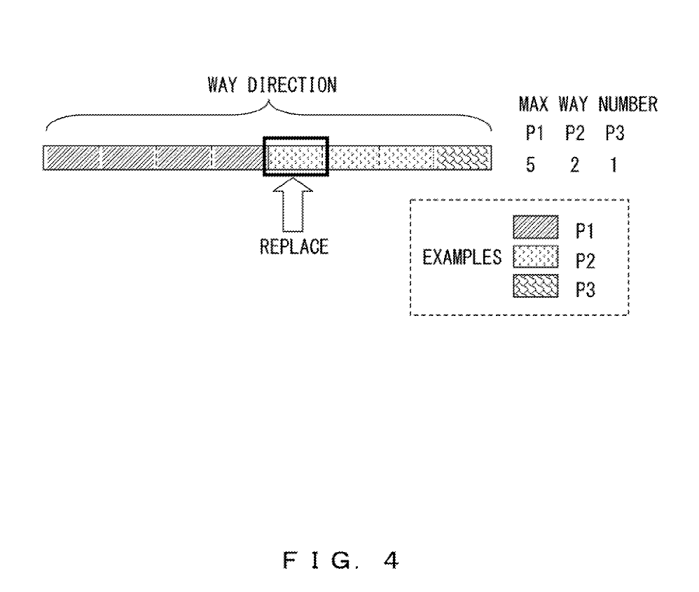

FIG. 4 is an explanatory view of a replacement operation of a cache block when a cache miss occurs. Assume that 4 blocks, 3 blocks and 1 block are respectively allocated to the PPID values P1, P2 and P3 as illustrated in FIG. 4 when the cache miss occurs. Here, when the cache miss occurs for P1, P1 does not exceed the MAX WAY number 105 in the index value, whereas P2 exceeds the MAX WAY number 105 in the index value. Accordingly, a replacement candidate is selected from among cache blocks 102 having P2 as a PPID value, data of a block indicated with an arrow in FIG. 4 is replaced with the data read from the main memory, and data requested by the PPID value P1 is loaded.

As described above, in this embodiment, a cache size allocation to each PPID is dynamically changed at timing when an access that causes a cache miss occurs.

To change a cache size allocation to each PPID in the cache memory 101, only operation to be performed is to change a map of MAX WAY numbers 105. An instruction of a MAX WAY number 105 can be issued along with a cache access instruction. With conventional techniques, it is needed to rewrite process IDs of all cache bocks 102 within the cache memory 101. In contrast, in this embodiment, a cache size allocation to each PPID can be changed when needed along with the cache access instruction. Note that all index values may be rewritten by one operation.

Additionally, even if the total of the numbers of ways requested by processes that are scheduled at the same time exceeds the number of ways provided in the cache memory 101, problems such as a system halt or the like do not occur although only a way conflict is caused.

In the case of the table example illustrated in FIG. 2, the number of cache blocks provided to the PPID value 3 is 11. Accordingly, for the PPID value 3, cache blocks cannot be allocated to all index values (16 indexes in FIG. 3). Therefore, the following allocation change in an index direction is needed in the example of partitioning the cache memory 101 in FIG. 3. Namely, for example, a MAX WAY number 105 for the PPID value P3 is set to 0 in an area of the first 5 indexes in the index direction, and a MAX WAY number 105 for the PPID value P3 is set to 1 only in an area of subsequent 11 indexes. Hence, when a cache access corresponding to the PPID value P3 occurs, it is needed to specify not the area of the first 5 indexes but the area of the first 11 indexes by an index within an instruction address on all occasions.

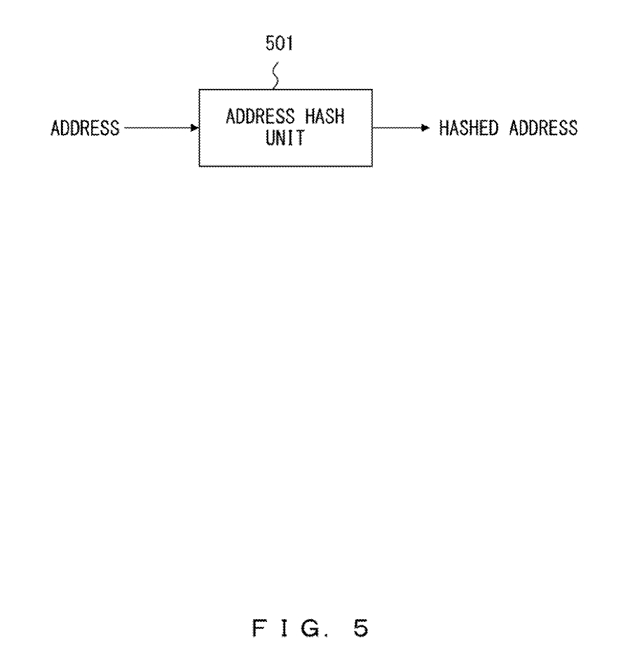

As this function, an address hash unit 501 as a hash mechanism illustrated in FIG. 5 is provided in this embodiment. With this hash mechanism, an index obtained by hashing a specified instruction address is prevented from generating an index of a prohibited area.

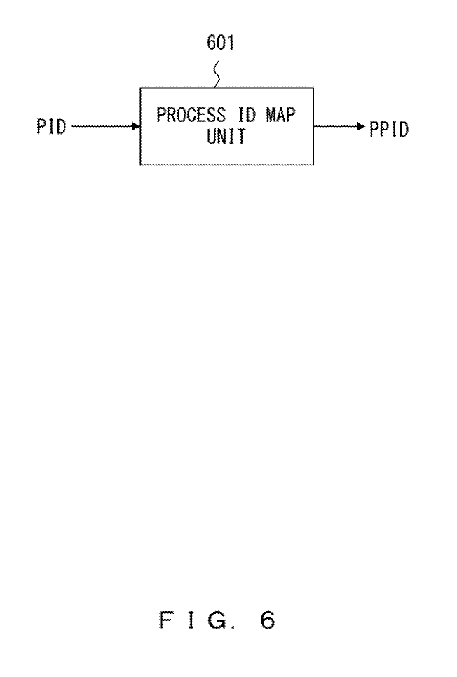

Additionally, a process ID managed by the OS has, for example, a value of 16 bits or more. Accordingly, if a process ID indicated with a value of 16 bits or more is held in each cache block 102 within the cache memory 101, the amount of added hardware increases. Accordingly, a process ID map unit 601 is provided in the embodiment as illustrated in FIG. 6. The process ID map unit 601 maps a process ID of a process that is executing a cache access instruction to a physical process ID (PPID) that can be handled by hardware of the cache memory 101. The PPID has, for example, a value as few as 2 bits, which specifies the number of partitioned sets. Therefore, the amount of hardware of the cache memory 101 can be prevented from increasing in comparison with a case of holding a process ID indicated, for example, with a value of 16 bits or more.

According to the above described hardware mechanism, the OS can freely schedule the cache memory 101 as a resource shared among processes based on a size and time as in the case of using the processor as a resource shared among processes with time-sharing scheduling.

For example, if the number of cache blocks is allocated to each of the PPID values as illustrated in the table example of FIG. 2, scheduling such as assigning a lower priority or reducing the number of allocated cache blocks is performed as follows if a value obtained by multiplying the number of cache blocks and a use time period of the number of the cache blocks increases.

P1: 64×1000 microseconds=64,000→Ex: Assigning lower priority

P2: 21×500 microseconds=10,500

P4: 11×2000 microseconds=22,000

As described above, a cache memory area can be arbitrarily partitioned in units of cache blocks in this embodiment. Accordingly, a shared cache memory is managed as a resource similarly to a calculation resource such as a calculation unit or the like included in a processor, and process scheduling can be optimized, whereby the effective performance of a processor can be improved.

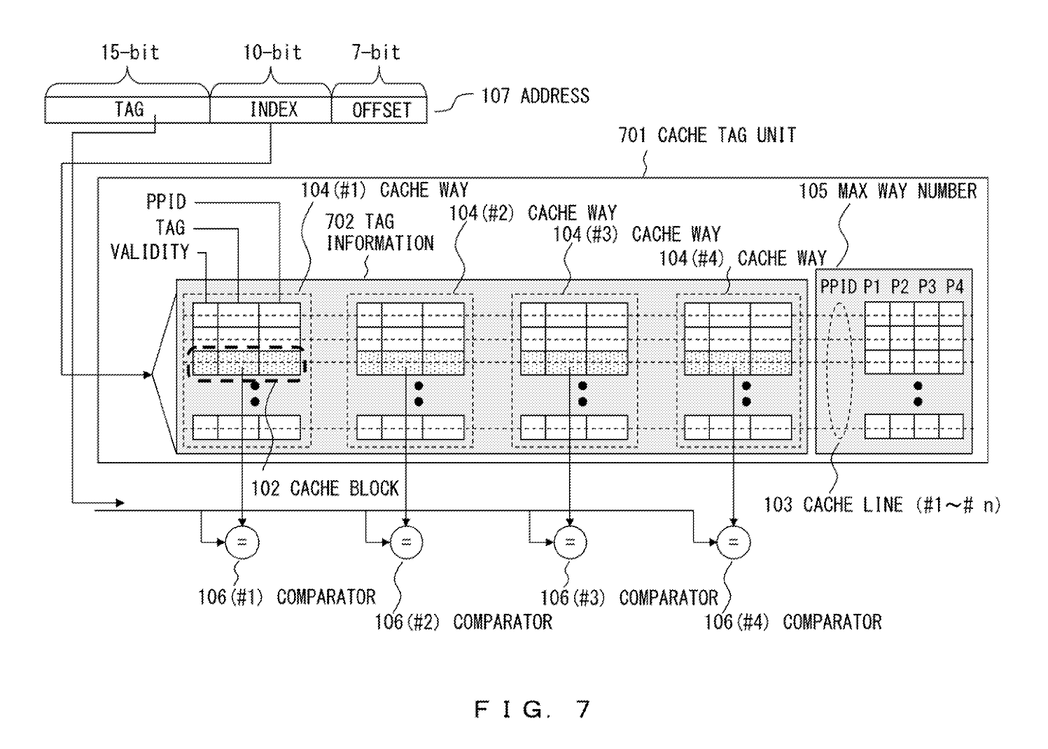

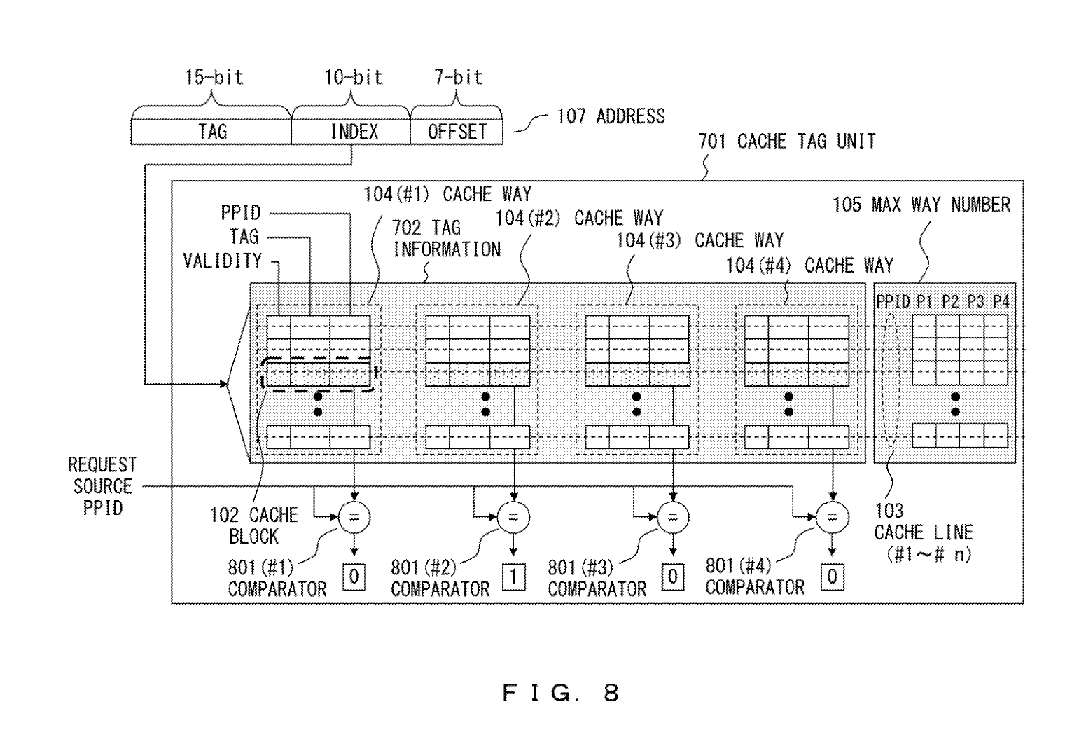

FIGS. 7 and 8 illustrate examples of a hardware configuration corresponding to the block configuration of the cache memory 101 illustrated in FIG. 1. In FIGS. 7 and 8, the same function parts as those of FIG. 1 are denoted with the same reference numerals.

For the cache blocks 102 illustrated in FIG. 1, the data unit (cache data unit) and the tag unit (cache tag unit) are implemented by separate RAMs (Random Access Memories). In the implementation example of FIGS. 7 and 8, a validity flag (1 bit), a tag (15 bits) and PPID (2 bits) are stored in the cache tag unit 701 as tag information 702 of each of cache blocks 102 that configure each set 103. Also a MAX WAY number 105 corresponding to each PPID value for each index value is held in the cache tag unit 701.

Note that the tag information 702 and the MAX WAY number 105 may be stored in further separate RAMs.

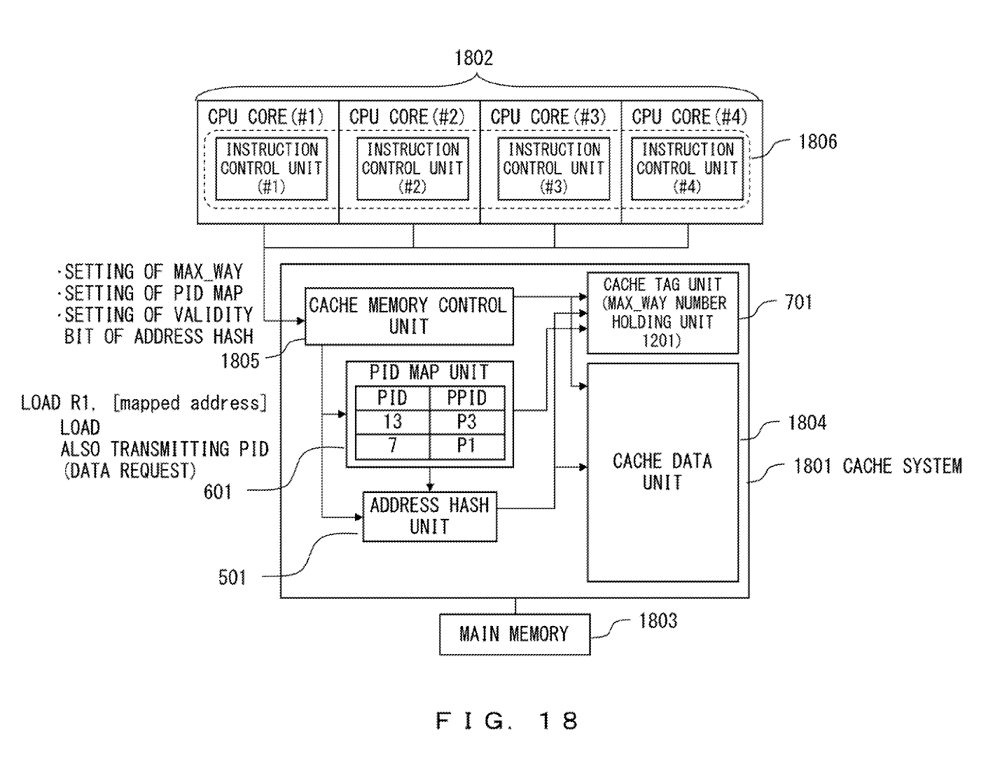

In FIG. 7, when a cache access is caused by a memory access request, a tag value of each cache block 102 (#i) in a specified index value is read from each of cache ways 104 #1 to #4, and the read tag value is input to each of comparators 106 #1 to #4. Consequently, as described above in FIG. 1, a cache hit is detected from a cache block 102 (#i), the tag value of which is compared by the comparator 106 that detects a match with a request source tag value among the comparators 106 #1 to #4. Then, data in the cache data unit (see 1804 of FIG. 18 to be described later) is read/written from/to the cache block 102 (#i) for which the cache hit is detected.

In the meantime, when a cache access is caused by a memory access request in FIG. 8, a PPID value of each cache block 102 (#i) in a specified index value is read from each of cache ways 104 #1 to #4 and input to each of comparators 801 #1 to #4.

Each of the comparators 801 #1 to #4 detects whether or not the read PPID value of each cache block 102 (#i) matches a value of a request source PPID. The request source PPID is a value obtained by translating a process ID of a process that is executing a cache access instruction with the process ID map unit 601 (FIG. 6). As a result, an output of the comparator 801 of a way where the PPID value of the cache block 102 (#i) matches the value of the request source PPID results in, for example, “1”, whereas an output of the comparator 801 of a way where the PPID value of the cache block 102 (#i) does not match the value of the request source PPID results in, for example, “0”.

Accordingly, the comparators 801 #1 to #4 output a bitmap indicating ways where the PPID value of the cache block 102 (#i) matches the value of the request source PPID.

In this embodiment, a total number of cache ways already allocated to a PPID value that causes a cache miss can be calculated in an index value where the cache miss occurs by counting up the number of “1” included in the bitmap. Then, as described above, a comparison is made between the total number of cache ways already allocated to the PPID value that causes the cache miss in the index value and a MAX WAY number 105 stored in association with the PPID value. Values respectively corresponding to the PPID values P1, P2 and P3 illustrated in FIG. 2 or 3 are stored as MAX WAY numbers 105 for each index in the cache tag unit 701 as illustrated in FIG. 7 or 8. P4 is similar although it is not illustrated in FIGS. 2 and 3. A MAX WAY number corresponding to the request source PPID among the MAX WAY numbers respectively corresponding to the above described P1, P2, P3, P4 and the like becomes a target of the process of the comparison with the total number of already allocated cache ways. If the total number of already allocated cache ways is smaller than the MAX WAY number 105, a replacement block is selected from among cache blocks that exceed the MAX WAY number 105 corresponding to other PPID values in cache blocks 102 already allocated to these PPID value in the index value.

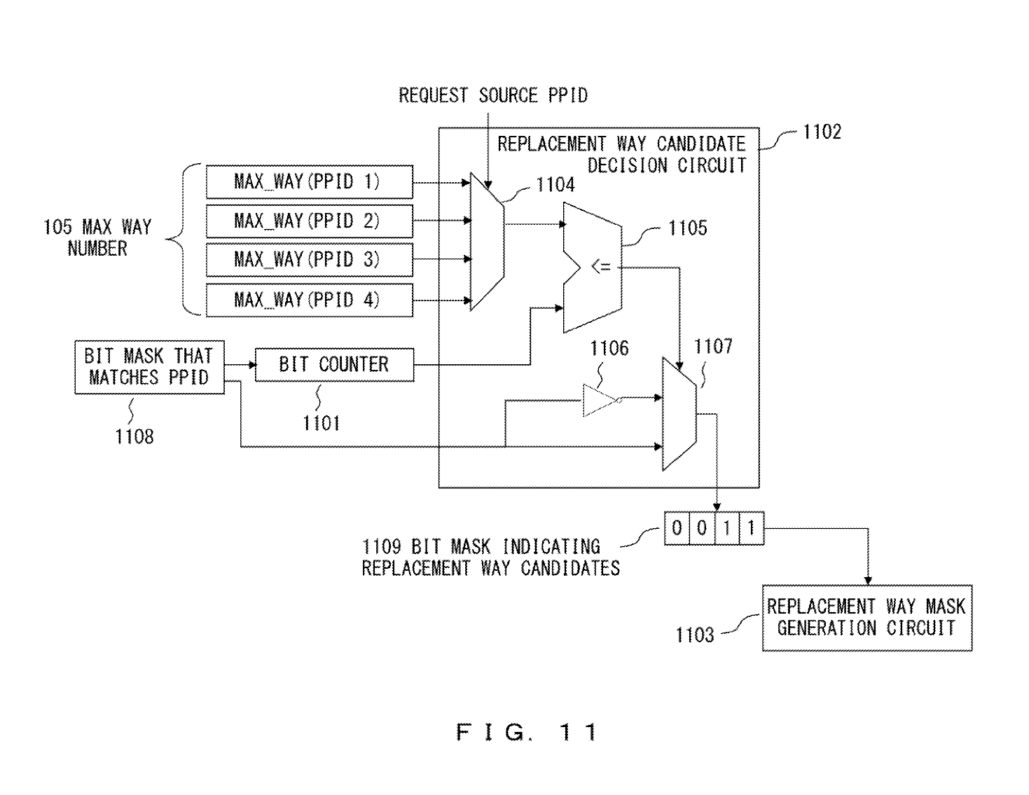

A hardware configuration of a replacement way control circuit for deciding a replacement block for a bitmap output by the comparators 801 #1 to #4 will be described later with reference to FIG. 11.

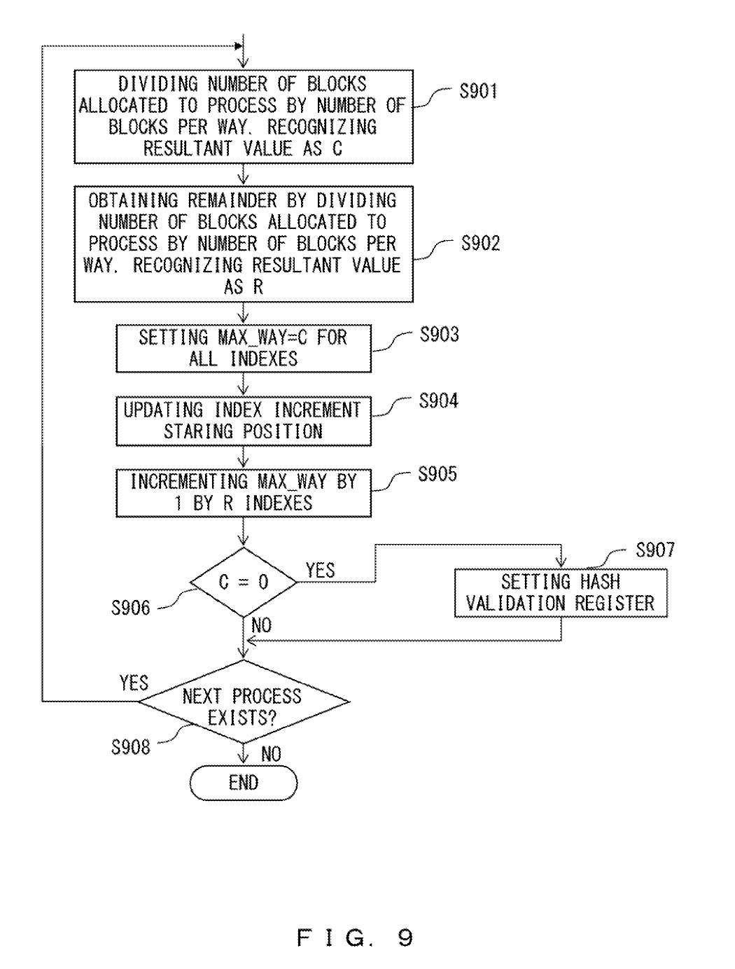

FIG. 9 is an operational flowchart illustrating a process for deciding a MAX WAY number 105 (FIG. 3) corresponding to each PPID value for each index value based on the table (FIG. 2) of the number of cache blocks, which the OS provides to each PPID value. This process is, for example, part of a process of the OS executed by a processor (such as a CPU core 1802 to be described later) that controls the cache system including the configurations illustrated in FIGS. 7 and 8.

Initially, the table configuration of FIG. 2 is referenced, and a value obtained by dividing the number of blocks allocated to a first process by the number of blocks in the index direction per way is set as C (step S901). Namely, C is the number of ways allocated to the process in the entire cache memory.

Next, a remainder value obtained by dividing the number of blocks allocated to the process by the number of blocks per way is set as R (step S902).

For example, the number of cache blocks of the first PPID value P1 in FIG. 2 is 64. Moreover, in FIG. 3, the number of blocks in the index direction per way is 16. Accordingly C=64/16=4, and the remainder of this division is 0. Therefore, R=0.

Next, MAX WAY number=C is set for all indexes (step S903). In the above described example of the PPID value P1, MAX WAY number 105=4 is set.

Next, a starting position (MAX WAY number increment starting position) at which a process for incrementing a MAX WAY number by the value of R is started is updated by sequentially accumulating the preceding value of R starting at an initial value 0 (step S904). Then, the MAX WAY number 105 is sequentially incremented by 1 starting at the MAX WAY number increment starting position by R indexes (step S905). In the above described example of the PPID value P1, R=0. Therefore, the increment process in step S905 is not executed, and the MAX WAY number increment starting position is left unchanged as the initial value 0.

Next, whether or not C=0 is determined (step S904).

If the determination in step S904 is “NO” (C≠0), the flow goes to step S908. As a result, the MAX WAY number 105 for the PPID value P1 results in 4 for all the index values as illustrated in FIG. 3.

After the determination in step S904, whether or not the next process exists is determined by referencing a data configuration corresponding to the example of the table configuration in FIG. 2 (step S908).

If the determination in step S908 is “YES” (the next process exists), the processes in and after step S901 are repeated.

In the example of the table configuration in FIG. 2, the PPID value P2 still exists next to the PPID value P1. Therefore, steps S901 and S902 are again executed. Since the number of cache blocks of the PPID value P2 in FIG. 2 is 21, C=21/16=1, and a remainder of this division is 5. As a result, R=5.

Then, step S903 is executed. In the example of the PPID value P2, MAX WAY number 105=1 is set.

Next, steps S904 and S905 are executed. In the example of the PPID value P2, an initial value of the MAX WAY number increment starting position is 0+R=0 by using R=0 in the above described access of P1. Moreover, since R=5 at this time, the MAX WAY number 105 is incremented by 1 starting at the MAX WAY number increment starting position=0 by R=5. The MAX WAY number 105 for the PPID value P2 results in 2 for the first 5 index values, and also results in 1 for the remaining 11 index values as illustrated in FIG. 3.

After the process of step S905, a determination in step S906 results in “NO”. Then, a determination in step S908 is performed. In the example of the table configuration in FIG. 2, the PPID value P3 still exists next to the PPID value P2. Accordingly, the determination in step S908 results in “YES”, and steps S901 and S902 are again executed. Since the number of cache blocks of the PPID value P3 in FIG. 2 is 11, C=11/16=0 and a remainder of this division is 11. Therefore, R=11.

Next, step S903 is executed. In the example of the PPID value P3, MAX WAY number 105=0 is set.

Then, steps S904 and S905 are executed. In the example of the PPID value P3, the MAX WAY number increment starting position initially results in 5 by accumulating R=5 in the above described access of P2. Since R=11 at this time, the MAX WAY number 105 is incremented by 1 starting at the MAX WAY number increment starting position=5 by R=11. As a result, the MAX WAY number 105 for the PPID value P3 results in 0 for the first 5 index values, and also results in 1 for the remaining 11 index values as illustrated in FIG. 3.

Next, since C=0, the determination in step S906 results in “YES”, and step S907 is executed.

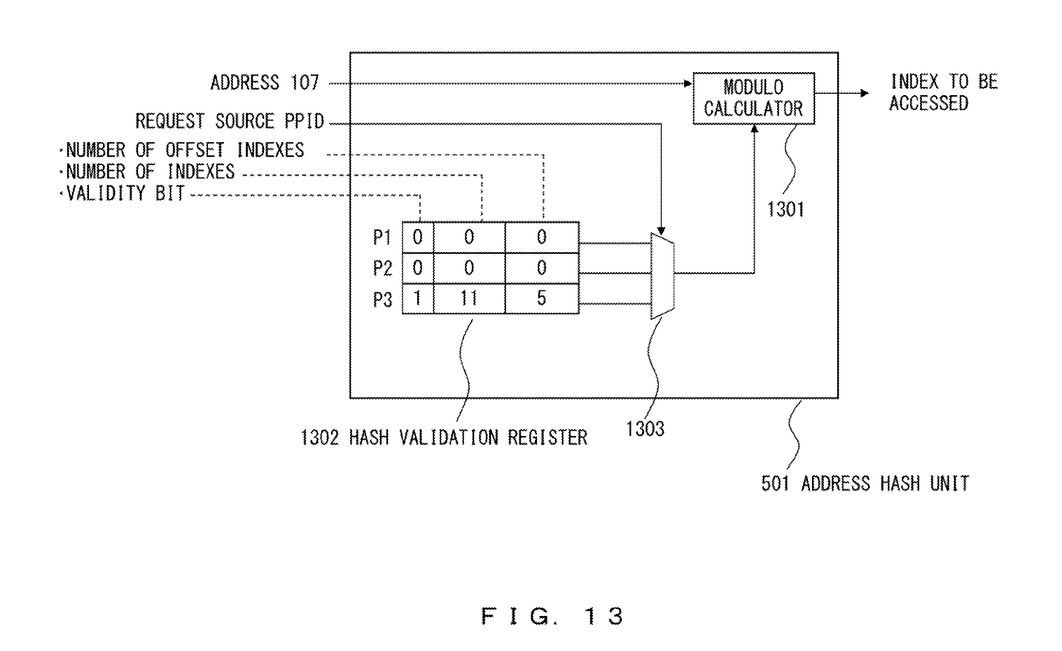

Here, a hash validation register (see the row of P3 in 1302 of FIG. 13 to be described later) for operating the address hash unit 501 of FIG. 5 is set for the PPID value P3.

After the process in step S907, no more PPID value exists next to the PPID value P3 in the example of the table configuration in FIG. 2. Accordingly, the determination in step S908 results in “NO”, and the process for deciding the MAX WAY number 105 according to the flowchart of FIG. 9 is terminated. If a PPID value P4 exists, similar processes are repeated also for P4.

According to the above described flowchart, the MAX WAY number 105 (FIG. 3) for each PPID value can be suitably decided for each index value based on the table (FIG. 2) of the number of cache blocks that the OS provides to each PPID value.

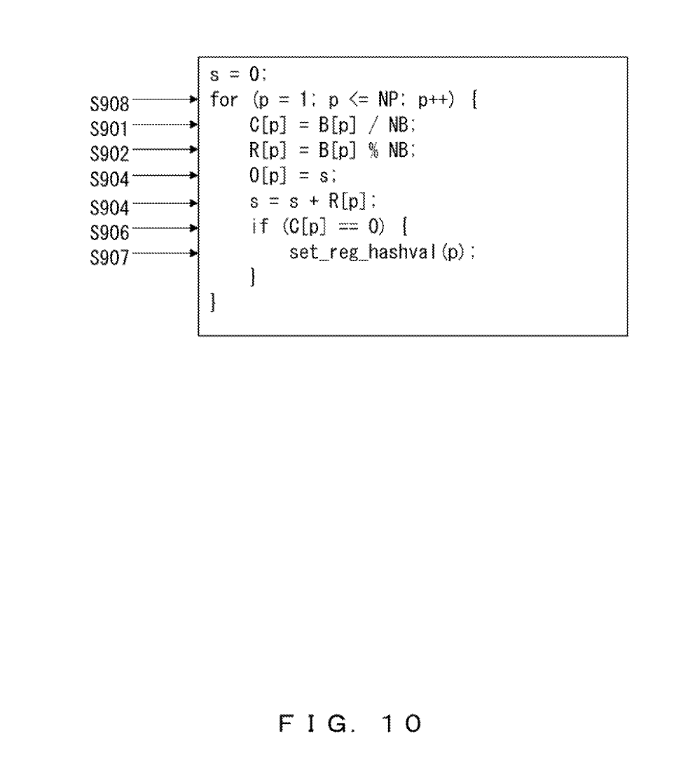

FIG. 10 illustrates a program pseudo code when the process represented by the flowchart of FIG. 9 is executed as a program process. On the left of program steps, step numbers of the corresponding processes in FIG. 9 are attached.

Initially, variables NP, NB, C, B, R and O are defined as follows.

NP: Number of Processes

NB: Number of Blocks per way

C[p]: Number of ways allocated to a process p

B[p]: Number of blocks allocated to the process p

R[p]: Number of blocks smaller than 1 way in the process p

O[p]: MAX WAY number increment starting position

Initially, the number of ways C[p] allocated to the process p is calculated for each process p referenced in the table configuration of FIG. 2 by dividing the number of blocks B[p] allocated to the process p by the number of blocks in the index direction per way (step S901).

Next, the number of blocks R[p] smaller than 1 way in the process p is calculated as a remainder obtained by dividing the number of blocks B[p] allocated to the process p by the number of blocks in the index direction per way (step S902).

Next, the MAX WAY number increment starting position 0[p]=s is set (step S904). Moreover, “s” is updated to s=s+R[p] (step S905).

If C[p]=0 for the process p (step S906), a set_reg_hashval (p) function is called to set the hash validation register (see 1302 of FIG. 13 to be described later) for operating the address hash unit 501 of FIG. 5 (step S907).

The above described operations are performed for all the processes referenced in the table configuration of FIG. 2. As a result, the number of ways C[p] allocated to the process p, the number of blocks R[p] smaller than 1 way in the process p, and the MAX WAY number increment starting position O[p] are calculated for each process p.

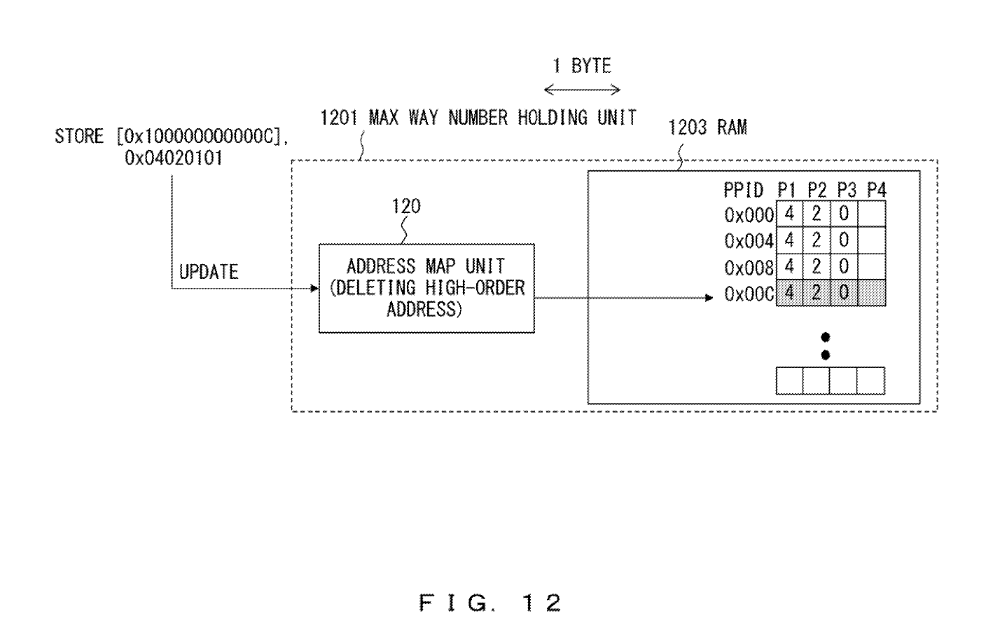

With these values, a STORE instruction (see FIG. 12 to be described later) for setting MAX WAY number=C[p] is executed for all the indexes within the cache tag unit 701 for each process p.

Next, a STORE instruction (see FIG. 12 to be described later) for setting MAX WAY number=C [p]+1 is executed for each process p starting at the MAX WAY number increment starting position within the cache tag unit 701 by R[p] indexes.

According to the above described program process, the process for deciding the MAX WAY number 105, which corresponds to the flowchart of FIG. 9, is executed.

FIG. 11 illustrates an example of a hardware configuration of a replacement way control circuit for deciding a replacement block for a bitmap output by the comparators 801 #1 to #4 of FIG. 8. The replacement way control circuit is configured with a bit counter 1101, a replacement way candidate decision circuit 1102 and a replacement way mask generation circuit 1103.

A bit mask 1108 that indicates a PPID match is an output of the comparators 801 #1 to #4 of FIG. 8. A MAX WAY number 105 is a MAX WAY number 105 that is read in association with an index value of the current cache access in association with each PPID value read in association with an index value of the current cache access in the cache tag unit 701 (see FIG. 8).

Initially, the bit counter 1101 counts up a bit that is set to 1 among bits of the bit mask 1108. As a result, the total number of cache ways currently allocated to PPID (request source PPID) corresponding to PID that has caused the current cache access is calculated.

Next, the selection circuit 1104 selects and outputs a MAX WAY number 105 corresponding to the request source PPID among the MAX WAY numbers 105 respectively corresponding to the PPID values.

A comparator 1105 makes a comparison between the number of cache ways currently allocated to the request source PPID, which is output by the bit counter 1101, and the MAX WAY number 105 that corresponds to the request source PPID and is output from the selection circuit 1104.

If the total number of cache ways currently allocated to the request source PPID is smaller than the MAX WAY number 105 corresponding to the request source PPID as a result of the comparison made by the comparator 1105, the selection circuit 1107 operates as follows. Namely, the selection circuit 1107 selects a bit mask obtained by inverting the bits of the bit mask 1108 with an inverter 1106, and outputs the bit mask as a bit mask 1109 that indicates a replacement way candidate. As a result, a way where cache blocks 10 already allocated to other PPID values except for the request source PPID value in a set 103 corresponding to the current cache access exist becomes a replacement way candidate.

In contrast, if the total number of cache ways currently allocated to the request source PPID reaches the MAX WAY number 105 corresponding to the request source PPID as a result of the comparison made by the comparator 1105, the selection circuit 1107 operates as follows. Namely, the selection circuit 1107 selects the bit mask 1108 without any change, and outputs the bit mask 1108 as the bit mask 1109 that indicates replacement way candidates. As a result, a way where cache blocks 10 already allocated to the request source PPID value exist becomes a replacement way candidate in a set 103 corresponding to the current cache access.

The replacement way mask generation circuit 1103 selects a replacement way from among replacement way candidates indicated by the bit mask 1109 for representing replacement way candidates, and generates and outputs a replacement way mask for representing a replacement way. More specifically, if the bit mask 1109 represents PPID except for the request source PPID as a replacement way candidate, the replacement way mask generation circuit 1103 operates as follows. Namely, the replacement way mask generation circuit 1103 selects a cache block in which the total number of cache ways already allocated exceeds the MAX WAY number 105 corresponding to other PPID values from among cache blocks 102 already allocated to these PPID values in the set 103 corresponding to the cache access. Then, the replacement way mask generation circuit 1103 generates a 4-bit replacement way mask where only a corresponding bit position of the way of the selected cache block is 1. If the bit mask 1109 represents the request source PPID as a replacement way candidate, the replacement way mask generation circuit 1103 generates a 4-bit replacement way mask where only a replacement way selected, for example, with an LRU algorithm from among least recently accessed ways is 1.

Data corresponding to a memory access request that causes a cache miss is output to the cache data unit, and a tag and PPID are output to the way corresponding to the bit position having a value 1 in the 4-bit data of the replacement way mask within the cache tag unit 701 (see FIG. 7). Moreover, an index within the memory access request specifies a set 103 of the cache data unit and the cache tag unit 701.

As a result, the data, the tag and the PPID are written to the cache block 102 of the selected way in the specified set 103 in the cache data unit and the cache tag unit 701.

The data written to the cache data unit is data read from a corresponding address in a main memory not illustrated if the memory access request is a read request. Alternatively, if the memory access request is a write request, the data written to the cache data unit is written data specified in the write request.

FIG. 12 illustrates an implementation example indicating a MAX WAY number update mechanism for updating a MAX WAY number 105 of each index value.

To a MAX WAY number holding unit 1201, an update value of the MAX WAY number 105 can be written by specifying an address from an instruction control unit (for example, 1806 of FIG. 18 to be described later) of the processor.

At this time, the instruction control unit assumes that a physical address specified by a STORE instruction for updating the MAX WAY number 105 has a physical address space of 52 bits.

An address map unit 1202 within the MAX WAY number holding unit 1201 translates the physical address specified by the STORE instruction into, for example, “0x00C” as an address accessible to a corresponding storage area in a RAM 1203 having an address space equal to the number of indexes of the cache. Namely, the address map unit 1202 executes a process for translating the address, for example, into “0x00C” by deleting high-order address information “0x1000000000” from the specified address “0x100000000000C”. Then, 4-byte data such as “0x04020101” is written by a STORE instruction to a storage area within the RAM 1203, such as “0x00C”, which is specified by the translated address. Then, for example, the highest-order 1 byte “04” within the 4-byte data specifies MAX WAY number 105=4 corresponding to PPID=P1 illustrated in FIG. 2 or FIG. 3. Moreover, the second highest-order 1 byte “02” similarly specifies MAX WAY number 105=2 corresponding to PPID=P2. In a similar manner, the third highest-order 1 byte “01” specifies the MAX WAY number 105=1 corresponding to PPID=P3. Then, the lowest-order 1 byte “01” specifies MAX WAY number 105=1 corresponding to PPID=P4 although this is not illustrated in FIGS. 2 and 3. Data of one combination of 4 bytes written by one STORE instruction is one combination of MAX WAY numbers 105 corresponding to P1 to P4 in one index value illustrated in FIG. 7 or FIG. 8.

As described above, the data in the RAM 1203 is managed by using 4 bytes as one combination. Therefore, a physical address specified by the instruction control unit in order to update the RAM 1203 is specified every 4 bytes. For example, “0x1000000000004” is specified next to “0x1000000000000”.

As described above in FIG. 8 and other figures, the cache tag unit 701 accesses a corresponding storage area in the RAM 1203 included in the cache memory 101, for example, according to an index value within the address 107 for a memory access at the time of a cache access.

As described above, if a capacity allocated to each PPID value of the cache memory 101 is changed, allocation of a MAX WAY number 105 for each index value within the RAM 1203 in the cache tag unit 701 that holds the MAX WAY number 105 may be changed. In this case, the above described instruction to update the MAX WAY number 105 by using the STORE instruction may be executed along with a cache access instruction, or may be executed collectively for all index values.

The above described MAX WAY number update process of FIG. 12 is executed, for example, by a cache memory control unit 1805 within a cache system 1801 illustrated in FIG. 18 to be described later according to an instruction issued from the instruction control unit 1806 within a CPU core 1802.

FIG. 13 illustrates an example of a hardware configuration of the address hash unit 501 illustrated in FIG. 5.

The hash validation register 1302 stores a validity bit, the number of indexes, and the number of offset indexes for each PPID value. As the validity bit, for example, a value 1 that indicates validity when a hash process is executed, or a value 0 that indicates invalidity when the hash process is not executed is set. As the number of indexes, the number of blocks R[p], which is smaller than 1 way and to which an index increment process is executed, is set. As the number of offset indexes, index position at which the above described increment process starts to be executed=MAX WAY number increment starting position O[p] is set.

As described in FIGS. 9 and 10, if C[p]=0 for the process p, the set_reg_hashval (p) function is called to set the hash validation register 1302.

Next, in FIG. 13, a selection circuit 1303 reads the validity bit, the number of indexes, and the number of offset indexes from an entry corresponding to the PPID value that matches the request source PPID value in the hash validation register 1302, and provides these pieces of data to a modulo calculator 1301. The request source PPID value is a value obtained by translating a process ID of a process that is executing a cache access instruction with the process ID map unit 601 (FIG. 6).

To the modulo calculator 1301, a high-order bit part of the address 107, which is specified by the cache access instruction, is input in addition to the validity bit, the number of indexes and the number of offset indexes, which correspond to the request source PPID, are input from the selection circuit 1303.

The modulo calculator 1301 calculates a value by adding the number of offset indexes to a remainder obtained by dividing the high-order bit part of the address 107 where the validity bit is set by the number of indexes. A calculation result is output to the cache tag unit 701 (FIG. 7) and the cache data unit (1804 of FIG. 18 to be described later) as a new index.

The modulo calculator 1301 outputs an index of the address 107 to the cache tag unit 701 (FIG. 7) and the cache data unit (1804 of FIG. 18 to be described later) without any change as a new index if the validity bit is not set.

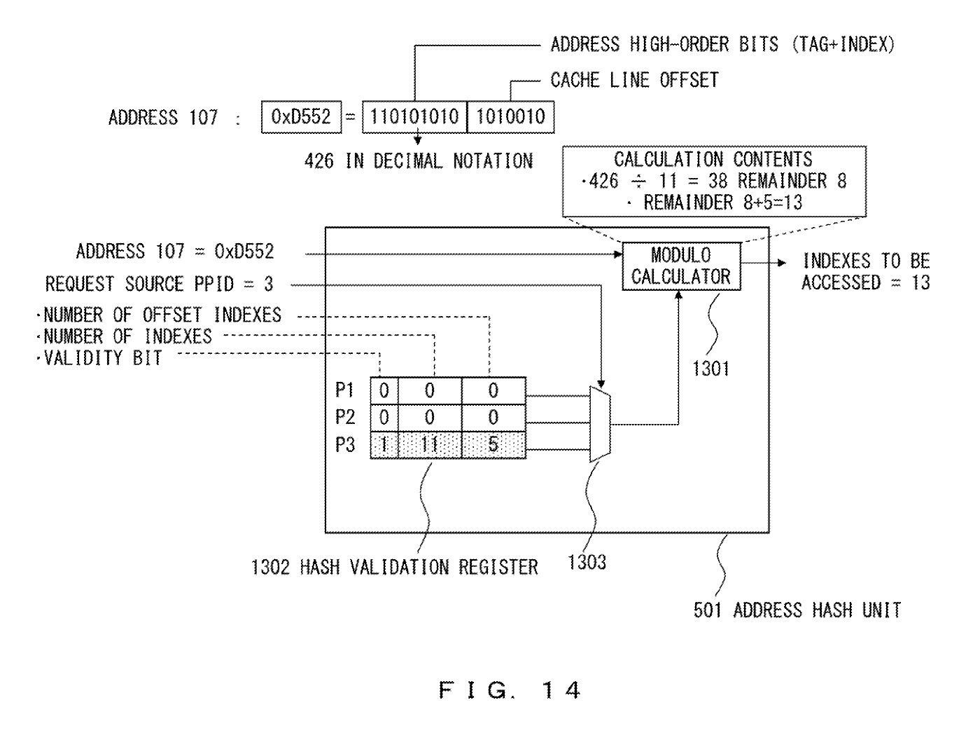

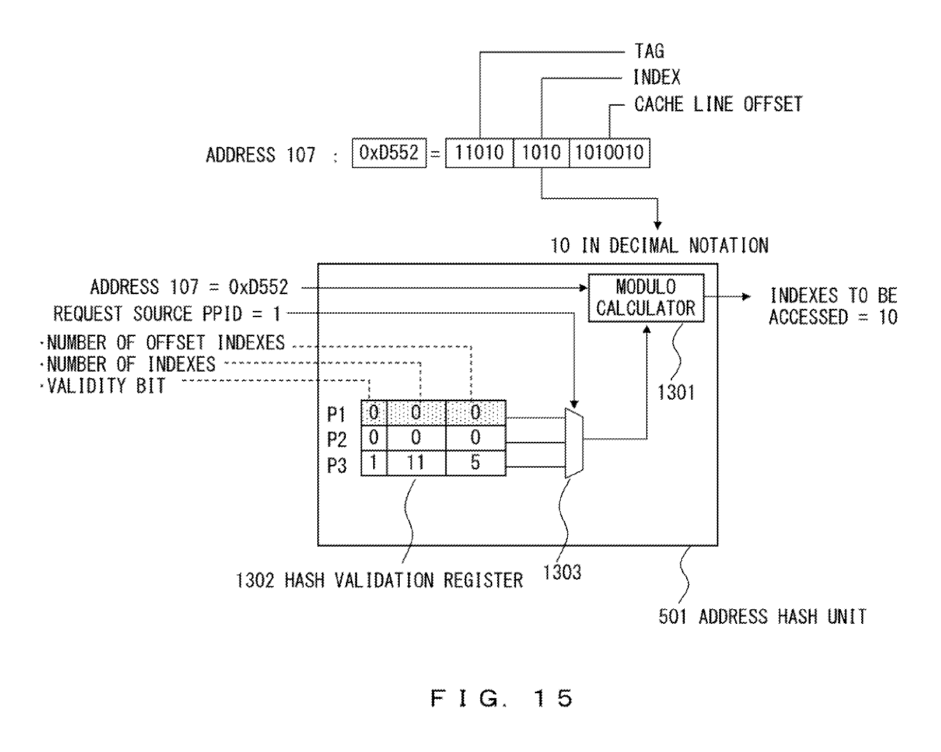

Specific operations of the address hash unit 501 having the above described configuration are described with reference to explanatory views of operations in FIGS. 14 and 15, and the above described FIGS. 2 and 3.

Here, in the hardware configurations of the cache tag unit 701 illustrated in FIGS. 7 and 8, a specific size of the cache tag unit 701 is, for example, as follows. Namely, in the address 107 of 32 bits specified by the program, a cache line offset, an index and a tag are specified with low-order 7 bits, succeeding 10 bits and high-order 15 bits, respectively. Accordingly, in the case of this example, the number of lines n of the set 103 specified with the 10-bit index is 2¹⁰=1024. The size of the cache tag unit 701, however, is not limited to this one. Another suitable size value can be adopted for each system. If a suitable size value is adopted for each system, a suitable bit width can be adopted also for the address 107.

In order to facilitate understanding, FIGS. 14 and 15 refer to an example where the address 107 is 16 bits, the cache line offset is 7 bits, the index is 4 bits, and the tag is 5 bits. In this example, the number of lines n of the set 103 is 2⁴=16 as indicated as the number of rows in the index direction in FIG. 3.

In the hash validation register 1302 of FIG. 13, C=0 in the case of PPID value=P3 if PPID value described in FIG. 3 is P2, P2, P3 and P-others except for P1, P2 and P3, and the total number of blocks is smaller than the number of indexes 16 in the index direction. Accordingly, as the number of indexes of P3, the number of blocks R[P3]=5 (see FIG. 10) smaller than 1 way is set. As the number of offset indexes, an index position at which the above described increment process starts to be executed=MAX WAY number increment starting position O[p] is set. For example, in FIG. 3, in the case of P3, R=[P2]5, namely, a value 5 equal to a remainder R[P2]=5 that is calculated in step S902 of FIG. 9 and obtained by dividing the number of blocks 15 allocated to the process P2 in the process P2 immediately before C=0 by the number of blocks 10 per way is set as O[P3].

As described above in FIGS. 9 and 10, if C[p]=0 for the process p, the set_reg_hashval (p) function is called to set the hash validation register 1302.

Namely, C [P3]=0 for PPID value=P3. Therefore, the following values are set in an entry corresponding to P3 of the hash validation register 1302. That is, as illustrated in FIG. 14, the validity bit=1, the number of indexes=R[P3]=11, the number of offset indexes=R[P2]=5 are set. For the other PPID values P1, P2 and the like, C [p]≠0. Therefore, the values are cleared to 0 in entries respectively corresponding to the PPID values P1 and P2 of the hash validation register 1302 as illustrated in FIG. 14.

Here, assume that “3” is input as a request source PPID value as illustrated in FIG. 14. As a result, the selection circuit 1303 reads the validity bit=1, the number of indexes=11, and the number of offset indexes=5 from the entry corresponding to PPID=P3 that matches the request source PPID value in the hash validation register 1302. Then, the selection circuit 1303 provides these pieces of numeric data to the modulo calculator 1301. If the validity bit is set to 1, the modulo calculator 1301 adds the number of offset indexes=5 to a remainder obtained by dividing a bit value of the high-order 9 bits of the tag+index of the address 107 by the number of indexes=11 as described above, and outputs an addition result as a new index.

Here, for example, a case where the following addresses are respectively input as the address 107 when the request source PPID value=3 is assumed is considered.

0xD152

0xD1D2

0xD252

0xD2D2

0xD352

0xD3D2

0xD452

0xD4D2

0xD552

0xD5D2

0xD652

0xD6D2

0xD752

FIG. 14 illustrates a case where “0xD552” is input as the address 107.

In these cases, bit values of the high-order 9 bits and decimal values corresponding to the bit values are as follows.

110100010=418

110100011=419

110100100=420

110100101=421

110100110=422

110100111=423

110101000=424

110101001=425

110101010=426

110101011=427

110101100=428

110101101=429

110101110=430

FIG. 14 depicts that the high-order 9 bits of the address 107 “0xD552” is “110101010” and its decimal representation is “426”.

The modulo calculator 1301 adds the number of offset indexes=5 to a remainder obtained by dividing each of the values of the high-order 9 bits by the number of indexes=11, and outputs an addition result as a new index.

418÷11=38 remainder 0, remainder 0+number of offset indexes 5=5

419÷11=38 remainder 1, remainder 1+number of offset indexes 5=6

420÷11=38 remainder 2, remainder 2+number of offset indexes 5=7

421÷11=38 remainder 3, remainder 3+number of offset indexes 5=8

422÷11=38 remainder 4, remainder 4+number of offset indexes 5=9

423÷11=38 remainder 5, remainder 5+number of offset indexes 5=10

424÷11=38 remainder 6, remainder 6+number of offset indexes 5=11

425÷11=38 remainder 7, remainder 7+number of offset indexes 5=12

426÷11=38 remainder 8, remainder 8+number of offset indexes 5=13

427÷11=38 remainder 9, remainder 9+number of offset indexes 5=14

428÷11=38 remainder 10, remainder 10+number of offset indexes 5=15

429÷11=39 remainder 0, remainder 0+number of offset indexes 5=5

430÷11=39 remainder 1, remainder 1+number of offset indexes 5=6

FIG. 14 depicts that a remainder obtained by dividing the high-order 9 bit value=110101010 (decimal value=426) by the number of indexes 11 is 8 and a new index value 13 is obtained by adding the number of offset indexes 5 to the remainder.

The above described specific example proves that 11 blocks of P3 in FIG. 3 can be sequentially accessed. Namely, a new index value falls within the range (P3) from 5 to 15 in the entire index range from 0 to 15. That is, when an instruction for the PPID value P3 is executed, the index of the address 107 can possibly be specified in the entire area in the index direction of FIG. 3. In contrast, the modulo calculator 1301 can perform mapping so that only the range of 11 indexes from 5 to 15 is specified.

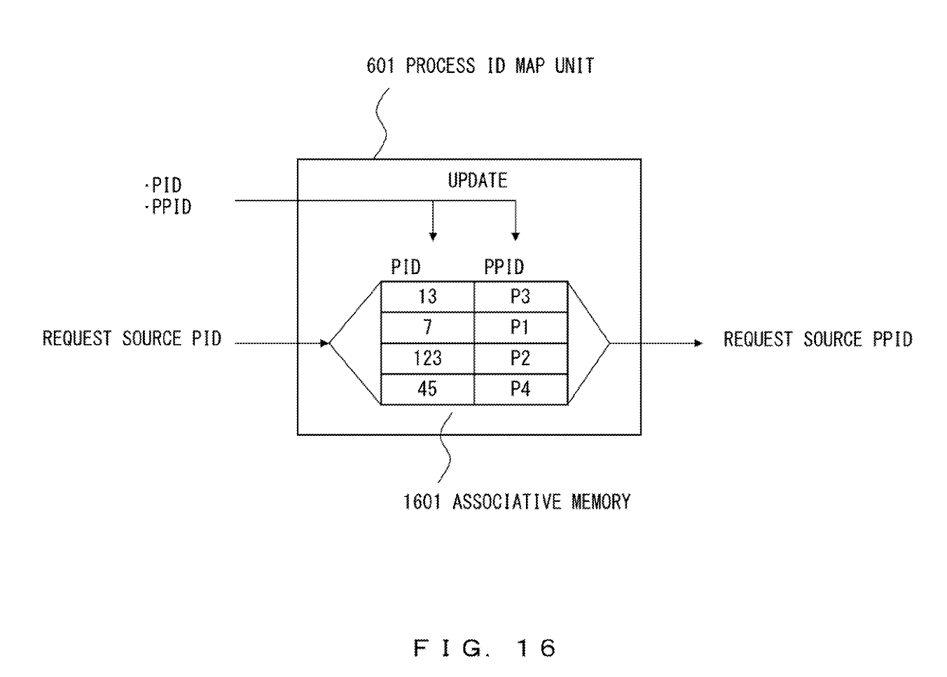

In the meantime, assume that “1” (or “2”) is input as the request source PPID value as illustrated in FIG. 15. As a result, the selection circuit 1303 reads the validity bit=0, the number of indexes=0, and the number of offset indexes=0 from the entry corresponding to the PPID value=P1 (or P2) that matches the request source PPID value in the hash validation register 1302. Then, the selection circuit 1303 provides these pieces of numerical data to the modulo calculator 1301. The modulo calculator 1301 operates as follows if the validity bit is not set to 1 as described above. Namely, the modulo calculator 1301 outputs the 4-bit index within the address 107 to the cache tag unit 701 (FIG. 7) and the cache data unit (1604 of FIG. 16 to be described later) without any change as a new index.

Here, assume that the above described addresses from “0xD152” to “0xD752” are input as the address 107 when the request source PPID value=1.

FIG. 15 illustrates a case where “0xD552” is input as the address 107.

In these cases, an index within the address 107 and a decimal value corresponding to the index are respectively as follows.

0010=2

0011=3

0100=4

0101=5

0110=6

0111=7

1000=8

1001=9

1010=10

1011=11

1100=12

1101=13

1110=14

The modulo calculator 1301 outputs the above described each 4-bit index without any change as a new index.

FIG. 15 depicts that the index “1010” (the decimal number 10) within the address 107 is output without any change as a new index.

According to the above described specific example, the range of all the indexes 0 to 15 can be specified as an index for the PPID value P1 or P2 of FIG. 3.

In this way if the number of blocks specified according to the table of FIG. 2 is smaller than 1 way for a certain process p, the following control is performed. Namely, a new index is mapped such that the index is specified only in an index range corresponding to a number of blocks R[p] that is smaller than 1 way that can be allocated to the process p from the MAX WAY number increment starting position O[p].

Here, the following address specification can be performed when contents of the hash validation register 1302 are updated by step S907 of FIG. 9 or FIG. 10. Namely, a read/write can be made from/to the hash validation register 1302 via an area mapped in a particular address space that is not used at the time of a memory access made to the main memory or the like similarly to the case of the update process for the MAX WAY number 105 of FIG. 12.

According to the above described configuration of the address hash unit 501 of FIG. 13, a control can be performed such that an index obtained by hashing an index of a specified instruction address 107 does not generate an index of a prohibited area.

FIG. 16 illustrates an example of a hardware configuration of the process ID map unit 601 of FIG. 6.

The process ID map unit 601 translates PID managed by the OS into PPID that is a physical process ID that can be handled by hardware of the cache memory 101.

The process ID map unit 601 is configured with an associative memory 1601 that can store a translation map and can be searched. The process ID map unit 601 may be configured with a register. The associative memory 1601 is searched by using a value of a request source PID as a key, and the value of matching PPID is output.

A value stored in the associative memory 1601 can be read/written via an area mapped in a particular address space that is not used at the time of a memory access to the main memory or the like similarly to the case of the process for updating the MAX WAY number 105 of FIG. 12.

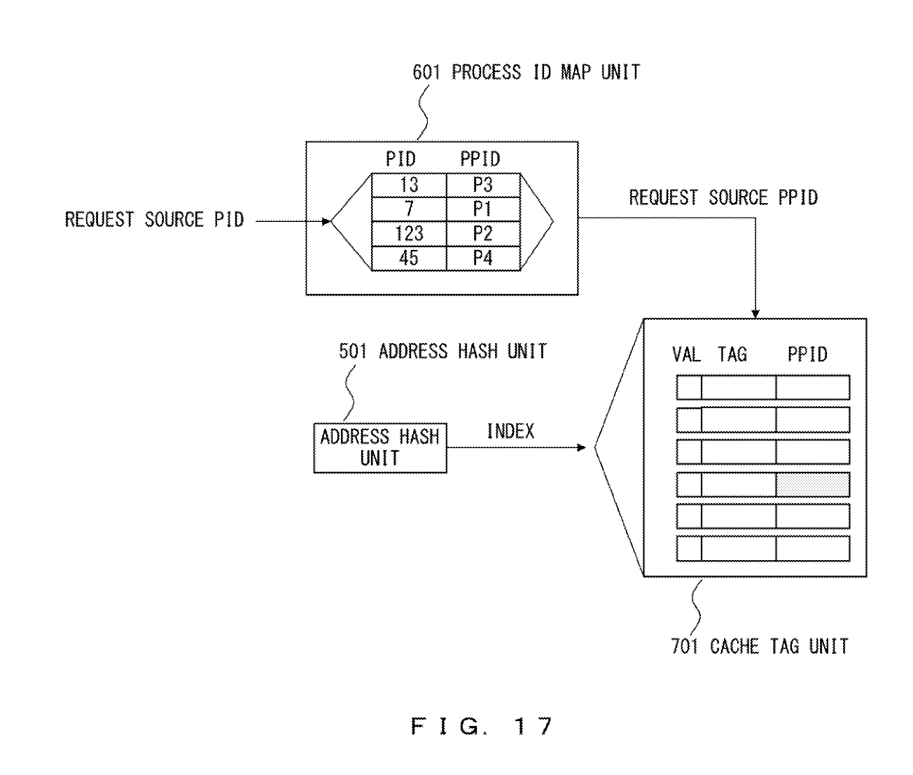

FIG. 17 illustrates a PPID write mechanism.

A cache block 102 within the cache tag unit 701 (FIG. 7) is updated with the value of a request source PPID output from the process ID map unit 601 illustrated in FIG. 16. As an index that accesses the cache block 102, a value output from the address hash unit 501 illustrated in FIG. 13 is used.

FIG. 18 illustrates an example of a configuration of a processor as an arithmetic processing device including the cache memory system according to this embodiment.

A cache system 1801 includes the cache tag unit 701 (including the MAX WAY number holding unit 1201) illustrated in FIG. 7, the address hash unit 501 illustrated in FIGS. 5 and 13, and the process ID map unit 601 illustrated in FIGS. 6 and 16. The cache system 1801 also includes a cache memory control unit 1805 configured to control cache accesses to the cache data unit 1804 for holding cache data, the cache tag unit 701 and the cache data unit 1804.

The cache memory control unit 1805 decodes a memory access instruction issued from an instruction control unit 1806 within each of CPU cores 1802 #1 to #4, and determines whether the instruction indicates an access either to a main memory 1803 or the cache data unit 1804.

The cache memory control unit 1805 issues an address 107 included in a memory access instruction (see FIGS. 1, 7 and other figures) to the cache tag unit 701 and the cache data unit 1804 if the memory access instruction indicates the access to the cache data unit 1804 as a result of decoding. After being processed by the address hash unit 501, this address 107 is output to the cache tag unit 701 and the cache data unit 1804.

Additionally, the cache memory control unit 1805 outputs PID, for which the memory access instruction is executed, to the process ID map unit 601 if the memory access instruction indicates an access to the cache data unit 1804. The process ID map unit 601 translates the PID into PPID, and outputs the PPID to the cache tag unit 701 as a request source PPID.

The cache memory control unit 1805 includes the hardware mechanisms illustrated in FIGS. 11 and 12, and performs controls such as the above described replacement way control, and MAX WAY number 105 update control.

When a cache miss occurs in the cache system 1801, data is read from the main memory 1803, and the read data is stored in a cache block 102 of a replacement way corresponding to a replacement way mask generated by the hardware configuration of FIG. 11 within the cache memory control unit 1805. As a result, a cache hit occurs at the time of the next access, whereby a high-speed access is implemented.

Additionally, the cache memory control unit 1805 performs the following operation if a STORE instruction to update a MAX WAY number 105 is issued from the instruction control unit 1806 (see FIG. 12). Namely, the cache memory control unit 1805 writes 4-byte data specified by a STORE instruction to a physical address specified by the above STORE instruction within the RAM 1203 (FIG. 12) in the cache tag unit 701 that holds MAX WAY numbers 105. As a result, the MAX WAY number 105 for each of the PPID values (P1, P2, P3, P4) in a corresponding index value is updated. The STORE instruction to update the MAX WAY number 105 may be executed when a memory access is made with a memory access instruction that causes a cache access, or may be executed collectively for all index values according to an instruction issued from the instruction control unit 1806.

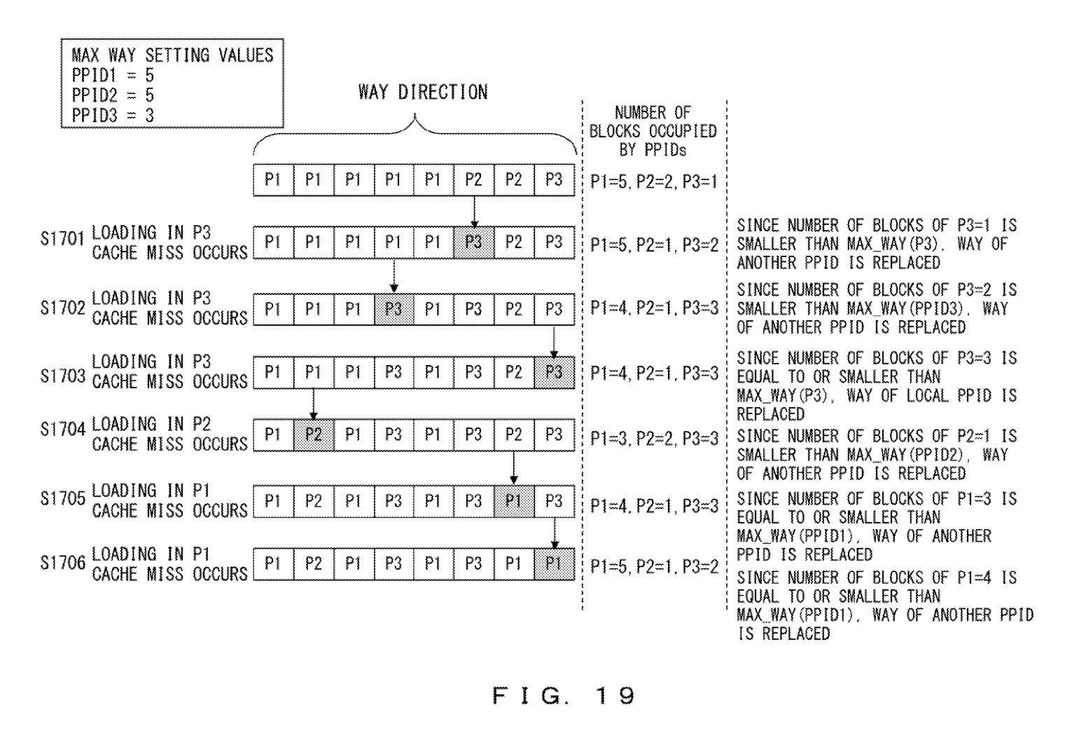

FIG. 19 is an explanatory view of an operation example when the total of the numbers of ways respectively requested by processes scheduled at the same time in the present embodiment exceeds the number of ways provided in the cache memory.

In this operation example, first assume that setting values of the number of MAX ways corresponding to the PPID values P1, P2 and P3 are 5, 5 and 3, respectively.

Initially, a cache miss is caused by executing a LOAD instruction included in a process of the PPID value P3 (step S1701). Since the number of blocks of P3=1 is smaller than MAX WAY number of P3=3, a way of another PPID value, the way of the PPID value P2 in the example of FIG. 19 is replaced.

Additionally, a cache miss is caused by executing a LOAD instruction included in the process of the PPID value P3 (step S1702). The number of blocks of P3=2 is smaller than MAX WAY number of P3=3. Therefore, a way of another PPID value, the way of the PPID value P1 in the example of FIG. 19 is replaced.

In this way, the number of blocks allocated to the PPID value P3 is only one at the start. When a memory access request included in the process of the PPID value P3 is made, the number of blocks is increased by replacing a block of another PPID until the MAX WAY number=3.

Also assume that a cache miss is caused by executing a LOAD instruction included in the process of the PPID value P3 (step S1703). Since the number of blocks of P3=3 is equal to or smaller than the MAX WAY number of P3=3, a way corresponding to the PPID value P3 that is a local PPID is replaced.

As described above, the number of cache blocks for the PPID value P3 does not become larger than the MAX WAY number even if the PPID value P3 equal to or larger than the MAX WAY number is requested.

Next, assume that a cache miss is caused by executing a LOAD instruction included in a process of the PPID value P2 (step S1704). Since the number of blocks of P2=1 is smaller than MAX WAY number of P2=5, a way of the PPID value P1 is replaced.

Thereafter, a memory access request included in the process of the PPID value P1 is made, and the number of blocks similarly increases up to the MAX WAY number=5 (steps S1705, S1706, . . . ). As described above, the number of blocks corresponding to each PPID value changes to approach the MAX WAY number, whereby the cache can be partitioned without any problems even if a MAX WAY number larger than the number of provided ways is set.

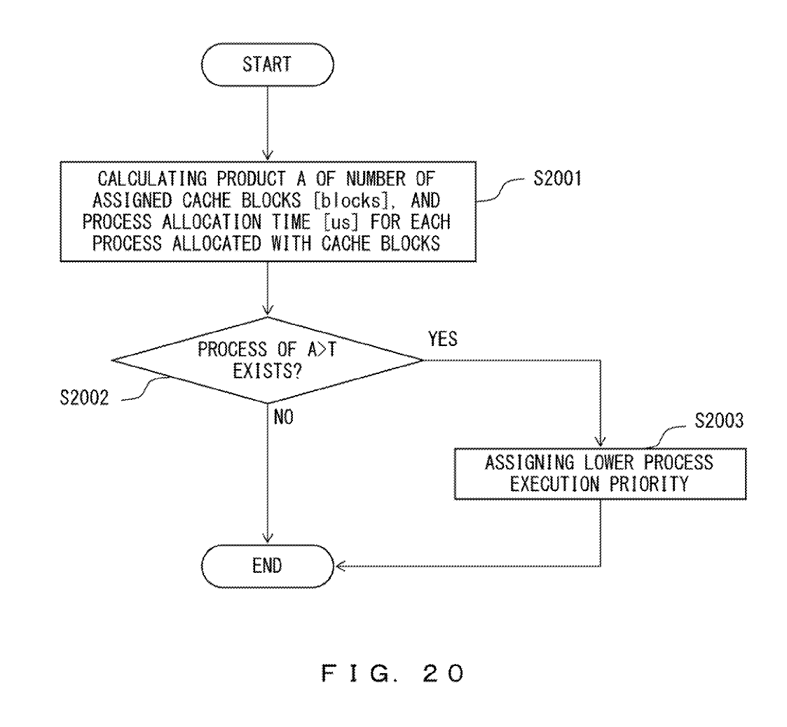

FIG. 20 is a flowchart illustrating operations for scheduling cache blocks based on a time and priority.

The process of this flowchart is executed every predetermined time period (such as 10 microseconds).

Initially, a product A of an allocated number of cache blocks [blocks] and a process allocation time [us] is calculated for each process to which cache blocks are allocated (step S201).

Next, whether or not a process of A>T exists is determined (step S202). Here, T is defined to be a system-dependent constant (threshold value).

If the determination in step S2002 results in “YES” (the process of A>T exists), a process execution priority is reduced (step S2003), and the current process is terminated.

If the determination in S2002 results in “NO” (the process of A>T does not exist), the current process is terminated without performing any operations.

In the above described embodiment, MAX WAY numbers are provided within the cache tag unit. However, the MAX WAY numbers may be controlled under the management of the OS.

According to the above described embodiment, a cache memory area can be arbitrarily partitioned in units of cache blocks, and a suitable number of cache blocks can be allocated to each process. As a result, the cache memory can be managed as a resource, and process scheduling can be optimized. Consequently, the effective performance of a processor can be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An arithmetic processing device, comprising:
an instruction control unit that executes a process including a plurality of instructions, and issues a memory access request including index information and tag information;
a cache memory unit that includes a plurality of cache ways having a block holding a tag, data corresponding to the memory access request for each of a plurality of indexes, and a process identifier for identifying a process executed by the instruction control unit;
an index decoding unit that decodes the index information included in the received memory access request, and selects a block corresponding to the decoded index information;
a comparison unit that makes a comparison between the tag information included in the received memory access request and a tag included in the block selected by the index decoding unit, and outputs data included in the block selected by the index decoding unit when the tag information and the tag match; and
a control unit that decides the number of cache ways used by the process identified with the process identifier based on maximum cache way number information set for each process identifier for each of the plurality of indexes of the cache memory unit.

2. The arithmetic processing device according to claim 1, wherein
the instruction control unit decides the number of cache ways used by the process identified with the process identifier based on the maximum cache way number information set for each process identifier by executing a control program for each of the plurality of indexes of the cache memory unit.

3. The arithmetic processing device according to claim 1, wherein
when the tag that matches the tag information does not exist in the selected block as a result of the comparison made by the comparison unit and a cache miss occurs, the cache memory unit replaces the data that is read from a main memory connected to the arithmetic processing device and corresponds to the memory access request with data held by any of blocks used by a process that is using cache ways the number of which exceeds set maximum cache way number information.

4. The arithmetic processing device according to claim 1, wherein
the control unit
calculates the number of cache ways allocated to each process identifier by dividing a maximum number of blocks allocated to each process identifier by the number of blocks per cache way,
calculates the number of cache ways which is smaller than the number of blocks per cache way in each process identifier by calculating a remainder by dividing the maximum number of blocks allocated to each process identifier by the number of blocks per cache way,
sets the number of cache ways allocated to the each process identifier as the maximum cache way number corresponding to the each process identifier for all indexes within the cache memory unit,
increments the maximum cache way number corresponding to the each process identifier by an index of the number of blocks smaller than one cache way in each process identifier, and
decides the maximum cache way number after being incremented as the number of cache ways used by the process identified with the each process identifier.

5. The arithmetic processing device according to claim 4, comprising
a cache memory control unit that allocates an area of the cache memory unit to a process corresponding to a request source process identifier in an index corresponding to the memory access request based on the request source process identifier, a process identifier held in the cache memory unit in association with each cache way of an index identified by the memory access request, and the maximum cache way number for each the process identifier which is decided in association with the index identified by the memory access request when the tag that matches the tag information does not exist in the selected block as a result of the comparison made by the comparison unit and a cache miss occurs.

6. The arithmetic processing device according to claim 5, wherein
the cache memory control unit comprises
a mask generation unit that generates a bit mask that indicates as a value “1” or “0” whether or not each process identifier held in the cache memory unit in association with each cache way of the index included in the memory access request matches the request source process identifier when the tag that matches the tag information does not exist in the selected block as a result of the comparison made by the comparison unit and a cache miss occurs,
a counting unit that counts the number of the value “1” or “0” of the generated bit mask,
a bit mask selection unit that outputs a bit mask obtained by inverting each bit of the bit mask outputted by the mask generation unit when the number of the value counted by the counting unit is smaller than a maximum cache way number corresponding to the request source process identifier, or outputs the bit mask outputted by the mask generation unit when the number of the value counted by the counting unit reaches the maximum cache way number corresponding to the request source process identifier, and
a replacement way decision unit that decides a cache way to be replaced from among the plurality of cache ways based on bit mask output by the bit mask selection unit.

7. The arithmetic processing device according to claim 4, comprising
an address hash generation unit that recognizes as an output of the index decoding unit a value obtained by adding a predetermined index starting position to a remainder obtained by dividing partial address information within a request address included in the memory access request by the number of blocks smaller than one cache way in the process identifier when the number of cache ways allocated to the process identifier is 0, or recognizes as the output of the index decoding unit the index information included in the request address when the number of cache ways allocated to the process identifier is not 0.

8. The arithmetic processing device according to claim 4, wherein
the cache memory unit includes a memory for storing the maximum cache way number for each of the plurality of indexes and for each process identifier,
the control unit issues an instruction to update the maximum cache way number by specifying an address that is not used by the memory access request, and
the cache memory unit translates the address specified by the control unit into an address of an address space of the memory, and updates the maximum cache way number corresponding to the process identifier.

9. The arithmetic processing device according to claim 1, comprising:
an associative memory unit that holds an association between an actual process ID of a process executed by the instruction control unit and the process identifier, the process identifier identifying each of a plurality of types of groups when the process executed by the instruction control unit is classified into the plurality of types of groups; and
a process ID map unit that obtains a process identifier corresponding to an actual process ID by searching the associative memory unit by using the actual process ID of the process executed by the instruction control unit as a key, and outputs the obtained process identifier to the cache memory control unit.

10. A controlling method of an arithmetic processing device having a cache memory unit including a plurality of cache ways each having a block holding a tag, data, and a process identifier corresponding to a process to be executed in association with a plurality of indexes, the controlling method comprising:
executing a process including a plurality of instructions;
issuing a memory access request to the data which includes index information and tag information;
decoding the index information included in the received memory access request;
selecting a block corresponding to the decoded index information;
comparing the tag information included in the received memory access request and a tag included in the block selected by the index decoding unit;
outputting data included in the block selected by the index decoding unit if the tag information and the tag match; and
deciding the number of cache ways used by the process identified with the process identifier based on maximum cache way number information set for each process identifier for each of the plurality of indexes of the cache memory unit.
